(19) United States
(12) Patent Application Publication
(10) Pub. No.: US 2023/0121640 A1
(43) Pub. Date: Apr. 20, 2023

(54) LAMINATED GLAZING WITH ELECTRICALLY CONNECTED LAYER AND METHOD OF PREPARING A LAMINATED GLAZING

(71) Applicant: CARLEX GLASS AMERICA, LLC, Nashville, TN (US)

(72) Inventors: Wladislaw BRONSTEIN, Trier (DE); Olivier FARREYROL, Wasserbillig (LU); Jean-Baptiste POUILLON, Grevenmacher (LU); Michael BARD, Wadern (DE); Yu MATSUDA, Nashville, TN (US); Emily Anne CURTIS, Nashville, TN (US); Linda Anne LEONARD, Bloomfield Hills, MI (US)

(21) Appl. No.: 17/914,055

(22) PCT Filed: Mar. 26, 2021
(86) PCT No.: PCT/US2021/024394

§ 371 Date: Sep. 23, 2022

Related U.S. Application Data
(60) Provisional application No. 63/000,222, filed on Mar. 26, 2020.
(60) Provisional application No. 63/000,243, filed on Mar. 26, 2020.
(60) Provisional application No. 63/000,261, filed on Mar. 26, 2020.

(51) Int. Cl. B32B 17/10; B32B 3/18; H05B 3/86

(52) U.S. Cl. CPC B32B 17/10385; B32B 3/18; B32B 17/10761; B32B 17/10036; B32B 17/10293; H05B 3/86; B32B 2250/03; B32B 2250/40; B32B 2305/34; B32B 2307/202; H05B 2203/013

(57) ABSTRACT

Disclosed herein is a laminated glazing having an electrically connectable layer, comprising: first and second glass substrates; an electrically connectable layer; interlayers rendering the electrically connectable layer positioned between interlayers; and a connection wire having first and second connection ends and a main portion positioned between the first and second connection ends. The first connection end of the connection wire is electrically connected to the electrically connectable layer, whereas the main portion of the connection wire is positioned within the interlayers.

### CROSS REFERENCE TO RELATED APPLICATIONS

This application claims priority to U. S. Provisional Application No. 63/000,261 filed on Mar. 26, 2020, entitled “LAMINATED GLAZING WITH ELECTRICALLY CONNECTED LAYER,” U. S. Provisional Application No. 63/000,243 filed on Mar. 26, 2020, entitled “METHOD OF PREPARING A LAMINATED GLAZING,” and U.S. Provisional Application No. 63/000,222 filed on Mar. 26, 2020, entitled “METHOD OF PREPARING A LAMINATED GLAZING,” the entire contents of which are incorporated by reference herein in their entirety.

### TECHNICAL FIELD

The present disclosure relates generally to laminated glazings having an electrically connected layer therein and to methods of preparing laminated glazings having an electrically connectable layer therein.

### DESCRIPTION OF RELATED ART

Laminated glazings are known to be formed with a switchable glass construction, for example and without limitation, as architectural or vehicle windows, including internal partitions or sunroofs, capable of selectively switching between an opaque (OFF) state for blocking, e.g., visible light, infrared and/or ultraviolet energy, and/or providing privacy, and a transparent (ON) state for allowing light or some light to pass through the construction. Some switchable glass constructions may also be configured to have a reverse-mode alignment, wherein in a default OFF state, the switchable glass construction is transparent, and in an ON state with an electric voltage applied, it is opaque.

The switching function, using, for example, a PDLC film (without limitation), may be accomplished by applying an electric field to a switchable PDLC material or layer within the glass construction. When a PDLC material is subjected to an applied electric field, discrete formations, such as droplets of a liquid crystal(s) dispersed throughout a polymer matrix in the PDLC, assume a transparent state because the long molecular axes of the liquid crystals align in a nematic (parallel) orientation in the direction of the electric field. The parallel orientation provides a direction for light to pass through.

PDLC materials are typically formed by initiating polymerization of a monomer mixed with a liquid crystal(s) and then curing the polymer matrix, resulting in a phase separation of the liquid crystal into distinct domains thought the rigid polymer backbone.

In a typical switchable glass construction, the switchable material (e.g., PDLC, SPD or electro-chromic) may be provided between two carrier substrates, which may include polymer films, such as polyethylene terephthalate (PET) films, which may he coated with a transparent conductive material (e.g., TCO such as indium tin oxide (ITO)) between each polymer film and the switchable material. The PDLC film including the polymer films, transparent conductive materials, and any interlayers may be laminated between at least one glass substrate on each side of the PDLC film.

To control such a switchable glass construction, electrical connections are required to couple the electrically functioning layers with an external power source. Where the switchable glass construction is divided into segments for a purpose of control on a segment basis, a power supply is needed for each of the segments, and therefore, electric connections are necessarily coupled to each of electronically functioning segments of the divided functional layer.

### SUMMARY OF THE DISCLOSURE

Disclosed herein is a laminated glazing having an electrically connectable layer, comprising: first and second glass substrates; an electrically connectable layer; interlayers, wherein the electrically connectable layer is positioned between interlayers; and at least one connection wire having first and second connection ends and a main portion positioned between the first and second connection ends. The first connection end of each connection wire is electrically connected to the electrically connectable layer, whereas the main portion of the connection wire is positioned within the interlayers.

According to an embodiment of this disclosure, the electrically connectable layer may include a switchable film, an illuminated display, a sensor, a light, an antenna, or a heatable coating which is laminated between the glass substrates. A switchable film may be chosen from any functional film that can be activated by voltage or signal application including, such as, e.g., a liquid crystal film, such as polymer dispersed liquid crystal (PDLC) or polymer network liquid crystal (PNLC), a nanoparticle film, such as a suspended particle device (SPD), or electrochromic films.

The switchable film may be formed with a switchable layer core positioned between first and second electrode layers, where the first electrode layer may be coated on a first film substrate and the second electrode layer may be coated on a second film substrate. Each electrode layer may include at least one busbar such that each electrode layer may be connected to a power source. in some embodiments, the first electrode layer may comprise at least two segments which may be electrically isolated from one another. Each segment may be electrically connected to connection wires via at least one busbar on each segment. The second electrode layer may be electrically connected to another connection wire which is different from the connection wires electrically connected to the segments, or namely from the connection wires connected to the first electrode layer. A segment may have more than one busbar, including where the segment has a length to width ratio of at least 5.

In some embodiments of the disclosure, the electrically connectable layer may include at least one display, at least two displays, or may include a heatable coating. The second connection end of the connection wire may be connected to a wire harness. The first connection end of the connection wire may have a looped shape or a zigzag shape.

In some embodiments of the disclosure, the interlayer may surround the electrically connectable layer. The interlayer may include a first interlayer provided between the first glass substrate and the electrically connectable layer, a surrounding interlayer provided around an edge off the electrically connectable layer, and a second interlayer provided between the second glass substrate and the electrically connectable layer.

In some embodiments of the disclosure, the main portion of the connection wire may be insulated. The first connection end may be adhered to the electrically connectable layer by an adhesive layer, which may include a conductive adhesive. The adhesive layer may include an adhesive tape. The adhesive tape may be a copper tape having adhesive on at least one side of the copper tape. In some embodiments, the adhesive tape may be double sided, such that it includes adhesive on opposite sides of the tape.

In another aspect of the disclosure, a method of preparing a laminated glazing is provided, comprising the steps of: placing at least one connection wire in a first interlayer, wherein each of the at least one connection wires includes a first connection end, a main portion arid a second connection end, wherein placing the at least one connection wire includes embedding the main portion of the connection wire in the first interlayer, placing an electrically connectable layer over the first interlayer such that at least one busbar on the electrically connectable layer overlaps with the first connection end of the at least one connection. wire and placing a surrounding interlayer over the first interlayer around the electrically connectable layer wherein the main portion of the at least one connection wire is positioned between the first interlayer and the surrounding interlayer; placing a second interlayer over the electrically connectable layer and the surrounding interlayer to provide an interlayer stack; placing the interlayer stack between a first glass substrate and a second glass substrate to provide a lamination stack; and laminating the lamination stack to provide a laminated glazing.

The electrically connectable layer may be placed either prior to or subsequent to the placement of the surrounding interlayer. The first connection end of the connection wire may have a looped shape or a zigzag shape. The electrically connectable layer may comprise at least two electrically isolated portions. Each electrically isolated portion may comprise at least one busbar which overlaps with at least one connection wire first connection end.

In some embodiments, the electrically connectable layer may be a switchable film. The switchable film may include a busbar folded around an edge of the switchable film. An adhesive layer may be placed on the first interlayer before placing the at least one connection wire wherein the first connection end at least partially aligns with the adhesive layer. The adhesive layer may comprise an adhesive tape, and the adhesive tape may comprise a copper tape having adhesive on at least one side of the copper tape. The adhesive tape may include a double-sided adhesive tape having adhesive on 2 opposite sides of the copper tape. The adhesive layer may include a conductive adhesive.

In yet another aspect of the disclosure, a method of preparing a laminated glazing is provided, comprising the steps of: placing a surrounding interlayer and an electrically connectable layer having at least one busbar on a first interlayer such that the electrically connectable layer fits within the surrounding interlayer; placing at least one connection wire on the surrounding interlayer and electrically connectable layer, wherein each connection wire includes a first connection end, a main portion, and a second connection end, wherein the first connection end of each connection wire overlaps with one of the at least one busbars, and wherein each main portion of the connection wires is embedded in the surrounding interlayer; placing a second interlayer over the electrically connectable layer and the surrounding interlayer to provide an interlayer stack; placing the interlayer stack between a first glass substrate and a second glass substrate to provide a lamination stack; and laminating the lamination stack to provide a laminated glazing.

The electrically connectable layer may be placed either prior to or subsequent to the placement of the surrounding interlayer. The first connection end of the connection wire may be in a looped shape or a zigzag shape. The electrically connectable layer may comprise at least two electrically isolated portions. Each electrically isolated portion may comprise at least one busbar which overlaps with at least one of the connection wire first connection ends.

In some embodiments, the electrically connectable layer is a switchable film. The switchable film may include a busbar folded around an edge of the switchable film. In some further embodiments, an adhesive layer may be placed at least partially over the first connection end on the at least one busbar, after placing the at least one connection wire, before placing a third interlayer. The adhesive layer may comprise an adhesive tape. The adhesive tape may comprise a copper tape having adhesive on at least one side of the copper tape. The adhesive layer may include a conductive adhesive.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a schematic plan view showing a laminated glazing according to an embodiment of the disclosure;

FIG. 2 is an enlarged plan view showing a part of the laminated glazing according to an embodiment of the disclosure;

FIG. 3 is a perspective cross-section showing a busbar area of the laminated glazing according to an embodiment of the disclosure;

FIG. 4 is a process cross section showing a step of providing an adhesive layer on an interlayer according to an embodiment of the disclosure;

FIG. 5 is a process plan view showing a step of providing an adhesive layer on the interlayer as shown in FIG. 4;

FIG. 6 is a process cross section showing a step of placing a connection wire on the adhesive layer and interlayer according to an embodiment of the disclosure;

FIG. 7 is a process plan view showing a step of placing a connection wire on the adhesive layer and interlayer as shown in FIG. 6;

FIG. 8 is a process cross section showing a step of placing an electrically connectable layer on the interlayer according to an embodiment of the disclosure;

FIG. 9 is a process plan view showing a step of placing an electrically connectable layer on the interlayer as shown in FIG. 8;

FIG. 10 is a process cross section showing a step of placing a surrounding interlayer on the interlayer according to an embodiment of the disclosure;

FIG. 11 is a process plan view showing a step of placing a surrounding interlayer on the interlayer as shown in FIG. 10;

FIG. 12 is a process cross section showing a step of placing a second interlayer on the interlayer and electrically connectable layer according to an embodiment of the disclosure;

FIG. 13 is a process plan view showing a step of placing a second interlayer on the interlayer and electrically connectable layer as shown in FIG. 12;

FIG. 14 is a process cross section showing a step of placing the interlayer stack shown in FIG. 12 between a first glass substrate and a second glass substrate according to an embodiment of the disclosure;

FIG. 15 is a process plan view showing a step of placing the interlayer stack between the first glass substrate and the second glass substrate as shown in FIG. 16;

FIG. 16 is a process cross section showing a step of placing a surrounding interlayer on an interlayer according to another embodiment of the disclosure;

FIG, 17 is a process plan view showing a step of placing a surrounding interlayer on the interlayer as shown in FIG. 16;

FIG. 18 is a process cross section showing a step of placing an electrically connectable layer having busbars on the interlayer according to an embodiment of the disclosure;

FIG. 19 is a process plan view showing a step of placing an electrically connectable layer having busbars on the interlayer as shown in FIG. 18;

FIG. 20 is a process cross section showing a step of placing connection wires on the electrically connectable layer and interlayer according to an embodiment of the disclosure;

FIG. 21 is a process plan view showing a step of placing connection wires on the electrically connectable layer and interlayer as shown in FIG. 20;

FIG. 22 is a process cross section showing a step of placing a second interlayer on the surrounding interlayer and the electrically connectable layer according to an embodiment of the disclosure; and

FIG. 23 is a process cross section showing a step of placing the interlayer stack shown in FIG. 22 between a first glass substrate and a second glass substrate according to an embodiment of the disclosure.

### DETAILED DESCRIPTION

In the following description, for purposes of explanation, specific details are set forth in order to promote a thorough understanding of one or more aspects of the disclosure. It may be evident in some or all instances, however, that many aspects described below can be practiced without adopting the specific design details described below.

A laminated glazing may include a first glass substrate and a second glass substrate laminated together with an interlayer material. Particularly, an interlayer may be a polymer adhesive, such as polyvinyl butyral (PVB), ethylene vinyl acetate (EVA), or an ionomer. The laminated glazing may further include an electrically connectable layer. The electrically connectable layer may include, for example, a switchable film, an illuminated display, a heatable layer, antennas, sensors, or lighting, laminated between the glass substrates. Switchable films may include, for example, a liquid crystal film, such as polymer dispersed liquid crystal (PDLC) or polymer network liquid crystal (PNLC), a nanoparticle film, such as a suspended particle device (SPD), or electrochromic films. In a typical switchable film, the switchable layer core including the switchable material (e.g., liquid crystal of PDLC or PNLC, suspended particle material of SPD, or electrochromic material) may be provided between two polymer films such as polyethylene terephthalate (PET) films, which may be coated with a transparent conductive material (e.g., TCO such as indium tin oxide (ITO)) between each polymer film and the switchable material. The switchable film including the polymer films, transparent conductive materials, and the switchable material and any interlayers may be laminated between a pair of glass substrates. The transparent conductive materials may serve as electrodes in the switchable film and may have separate electrical connections. The electrically connectable layer may be formed as one film incorporated in the glass construction. In some embodiments, the electrically connectable layer may be divided into multiple segments, which are electrically isolated from one another and which each require an electrical connection. When such an electrically connectable layer with multiple segments is used for a switchable sunroof of a vehicle, a driver or passengers may control the transparency of each segment to render some segments fully transparent as well as the remaining segments dimmed or blocking light.

The laminated glazing may include a first interlayer between a first glass substrate and the electrically connectable layer and a second interlayer between the second glass substrate and the electrically connectable layer. It may be preferable that the electrically connectable layer does not reach the edge of the laminated glazing. For example, some electrically connectable layers may be subject to corrosion if exposed to certain external environments, including moisture. The electrically connectable layer may include a connectable coating on a substrate and the edge of the substrate may extend farther than the edge of the connectable coating. Where the electrically connectable layer is a film laminated within the glazing, the film may not extend to the edge of the glazing. Without the electrically connectable layer at a glazing periphery, there may be a change in thickness around the edge of the electrically connectable layer within the laminated glazing. To compensate for the resulting change in glazing thickness, another interlayer, or namely a surrounding interlayer, may be provided between the first and second interlayers and may surround the electrically connectable layer. The surrounding interlayer may be formed with an opening in which the electrically connectable layer may fit.

During lamination, a lamination stack, including glass substrates, interlayers, and any materials to be laminated between the glass substrates, is deaired and autoclaved. The deairing process may include removing air from between the stack layers to eliminate air pockets in the laminated glazing. in some laminated glazings, the inclusion of materials within the glazing may complicate the deairing process. For example, connecting materials, such as copper tape, may impede the deairing process. Copper tape may be used in typical glazings to connect an electrically connectable layer to an outside power source. The copper tape may extend through the glazing from the electrically connectable layer through a glazing periphery to a position where the tape may be connected to an external power source. The size and location of the copper tape may contribute to difficulty in deairing where the busbars may block air from escaping to the edge of the lamination stack. For example, the copper tape may be adhered to an interlayer such that air may not pass through the copper tape and that interlayer, which may create an obstacle for some air to be removed from the lamination stack, including where air may be stuck between pieces of copper tape. In some glazings, copper tape extending around the glazing periphery may be aligned with an opaque print, such that the tape is not visible to an observer. An opaque print may extend around a periphery of the glazing and may have a width to cover busbars and copper tape. The area required for connections between busbars and a power source may depend on how large the connections, such as copper tapes, are which may correlate to a required area of opaque printing. It may be desirable in the art to provide electrical connections with reduced materials around the periphery of the glazing.

The electrically connectable layers may be connected via busbars to a power source which may provide power to the material within the glazing. Multiple busbars may be used for an electrically connectable layer. For example, a heatable coating layer may have at least two busbars. In some embodiments, a switchable film. may have multiple electrodes which each require at least one busbar. In some electrically connectable layers, multiple busbars may be used to provide a uniform electrical field. Where the electrically connectable layer includes multiple electrically isolated portions, each portion may include a at least one busbar for connection to the power source. In some embodiments having a switchable film, where an electrically isolated portion has a length to width ratio of at least 5, the electrically isolated portion may preferably have at least two busbars. Where a segment has multiple busbars, the busbars may preferably be positioned on opposite sides of the electrically isolated segment to ensure uniform switching of the electrically isolated segment. Electrically isolated portions may be physically separated in an electrically connectable layer. For example, an electrically heatable coating may include deletions which isolate sections of the coating from each other or an illuminated display may be provided in multiple pieces that are physically isolated from each other. Where an electrically connectable material is deleted, any suitable deletion methods may be used such as a laser deletion or mechanical deletion. A switchable film may include a switchable layer core between electrode layers, which are coated on film substrates. The electrode layers may each be connected to a power source to provide power to the switchable film. Electrically isolated portions of the switchable film may be formed by deletions in one or both of the electrode layers forming segmentation of the layer. One of the electrode layers may remain intact in a segmented switchable film depending on the desired segmentation pattern. Electrically connectable layer segments may be connected so as to be electrically controlled together or independently.

Typically, busbars may include busbar material, such as a silver- or tin-containing material. In some glazings, a copper tape may be positioned over the busbar material to provide an even busbar surface which may be preferable for providing an electrical connection. Where the electrically connectable layer is segmented with isolated portions, multiple busbars may be required so that each segment of the layer may be electrically connected. Each electrically isolated portion may include at least one separate busbar. As the number of busbars required increases, the materials required for the busbars and connections increases, which may increase the impediment to deairing.

The present disclosure includes embodiments of laminated glazings having reduced connector presence for electrically connectable layers within the laminated glazing. Particularly, a laminated glazing may be provided having an electrically connectable layer connected to a power source via a wire-based connection. The wire may include first and second connections ends separated by a main portion. The first connection end may be electrically connected to a busbar on the electrically connectable layer, and the second connection end may connect to a connector or wire harness which extends outside of the glazing such that it may be connected to a power source. A wire harness laminated within the glazing may be connected to a connector Which may extend out of the glazing. The main portion of the wire may be located within the interlayer materials. Preferably, the main portion of the wire may be positioned around the electrically connectable layer.

An electrically connectable layer within a laminated glazing may include a busbar for connecting to a power source. Connection wires may be used to connect the busbar to a power source and provide electrical connection to the electrically connectable layer. The first connection end(s) of the wire(s) may be aligned with the busbar(s) and may be shaped to ensure a proper connection between the busbar and the connection wire. For example, a first connection end may be shaped with loops or in a zigzag shape to increase the surface area of the busbar aligned with the connection wire. Each busbar may connect with one or more connection wires. It may be preferable that the first connection end does not overlap with the electrically connectable material of the electrically connectable layer other than through the busbar to avoid interference in the electrical circuit. It may thus be preferable to position the busbar along the edge or close to the edge of an electrically connectable layer to aid in the positioning of the connection wires.

It may be preferable to mechanically attach the first connection ends to the busbars to ensure they do not separate during a lamination process and to keep electrical contact between the connection wires and the busbars and the electrically connectable layer. In some embodiments, the first connection ends of the wires may be soldered to the busbars. In certain embodiments, the first connection ends of the wires may be positioned on a busbar and covered with an adhesive, such as an adhesive copper tape. The copper tape may include an adhesive facing the first connection end, which may include a conductive adhesive. In some further embodiments, the copper tape may be double-sided having adhesive on opposing sides of the tape. Where a copper tape has two adhesive surfaces, a surface facing away from the first connection end may be non-conductive and an adhesive facing the first connection end may preferably be a conductive adhesive.

The main portion of the connection wires may extend through the interlayers outside the edge of the electrically connectable layer. The main portion of the connection wires may be embedded between interlayers and may be positioned such that the main portions are isolated from one another. The main portion of the connection wires may be insulated. Insulating materials may include, for example, a resin coating, which may include a base coat and a colored overcoating in some embodiments. The coating may not extend to the first connection end or the second connection end of each connection wire. Insulation around the main portion of the wire may prevent interaction between the connection wire and the interlayers, including plasticizers in the interlayers. The main portion of the connection wires may be positioned in any desirable shape, including the shape of an edge of the electrically connectable layer or the glass substrates of the glazing. In some embodiments, the main portions may extend along the edge of the electrically connectable layer, which may include around a corner of the electrically connectable layer. Where a glazing includes more than one connection wire, the wires may have the same or different shapes. The wires may be positioned between the interlayers such that they do not overlap with each other.

The main portion of the connection wires may extend toward an edge of a laminated glazing where second connection ends of the connection wires may be attached to a wire harness which may consolidate the connection wires to a single connection element for connecting to a power source. Particularly, the second connection ends may connect to a wire harness within the laminated glazing such that one connector from the wire harness extends out of the laminated glazing for connection to a power source.

A connection wire may he any suitable material, such as copper, aluminum, silver, gold, tungsten, or any other conductive metal or alloy to provide sufficient electrical power from a power source to the electrically connectable layer. The connection wire may include a copper wire having suitable thickness to provide power to an electrically connectable layer. For example, the diameter of the connection wire may be 0.25 mm or less, preferably 0.15 mm or less. The amount of power required may depend on the type of electrically connectable layer. For example, a switchable film may require less power than a beatable coating. A thicker wire or multiple wires may be used to provide more power than a relatively smaller wire. The connection wire diameter may be determined to provide a suitable current density in the wire. For example, where the wire is copper, a current density may preferably be 15 A/mm² or less, more preferably 6 A/mm² or less, and even more preferably 4 A/mm² or less. The suitable current density may depend on the wire material used. In some embodiments, a bare wire without additional insulation material may be used for this connection wire as the connection wires may be entirely covered, except for the electrically contacting portions, and insulated by interlayers after the autoclaving process. In some other embodiments, the main portion of the connection wires may be insulated.

Use of a connection wire is advantageous for the deairing process during lamination. Where a copper tape might block air passage during the deairing process and also may reduce the productivity of the deairing process, the connection wire is desirable for the deairing process, because air may readily pass around the wires, thereby rendering the deairing process faster and more effective.

Where an electrically connectable layer includes more than one connection wire, the wires may be attached to a power source or controller in parallel or in series, and the connection wires may be powered together or separately. It may be desirable to power particular parts of a connectable layer while leaving other portions unpowered in some instances, where in others, it may he preferable to uniformly power the electrically connectable layer.

In certain embodiments disclosed herein, the electrically connectable layer may include a switchable film. A segmented switchable film, as described above, may include at least n+1 busbars where n is equal to the number of segments in the switchable film. A segmented electrode layer may include at least one busbar in each segment, or portion, and a non-segmented electrode layer may include a busbar. Each busbar may include a surface for connection to a connection wire, and there may be at least one connection wire for each busbar. Where the switchable film includes two electrode layers, each connection wire may be aligned with only one of the electrode layers. For a segmented electrode layer, a connection wire may connect to one segment of the electrode layer without contacting the other segments.

Some embodiments may include an illuminated display as an electrically connectable layer. An illuminated display may include, for example, a substrate layer having a coating thereon which may illuminate under electrical power. Such a display may include one or more separate laminated pieces in a laminated glazing. For example, separate displays may be used in a glazing to provide more than one display option and location. The display may share information internally and/or externally in a vehicle, including giving information to a pedestrian, such as vehicle movement or occupancy. A laminated display may require electrical connection to a power source in order to be illuminated. A connection wire as discussed herein may be used to connect the illuminable display to a power source via a busbar on the illuminable display.

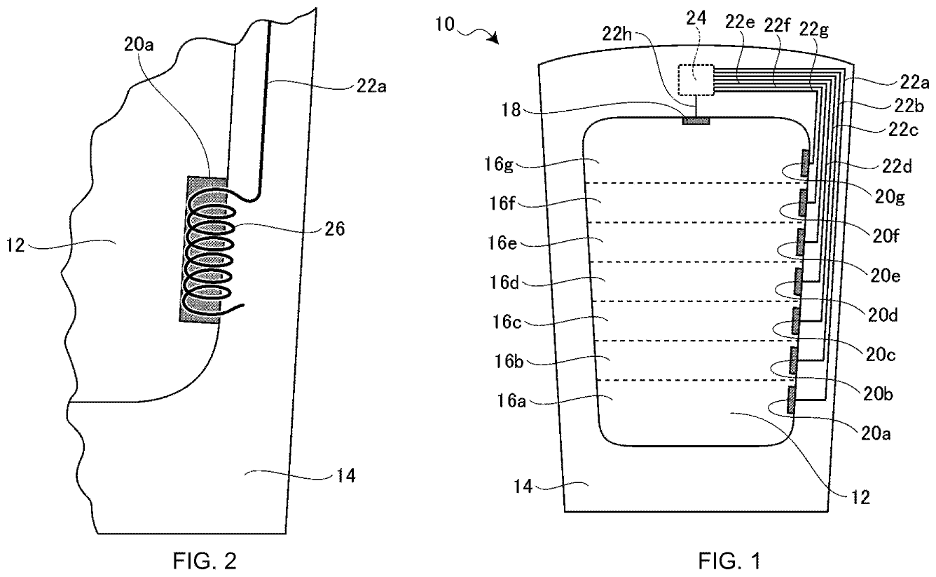

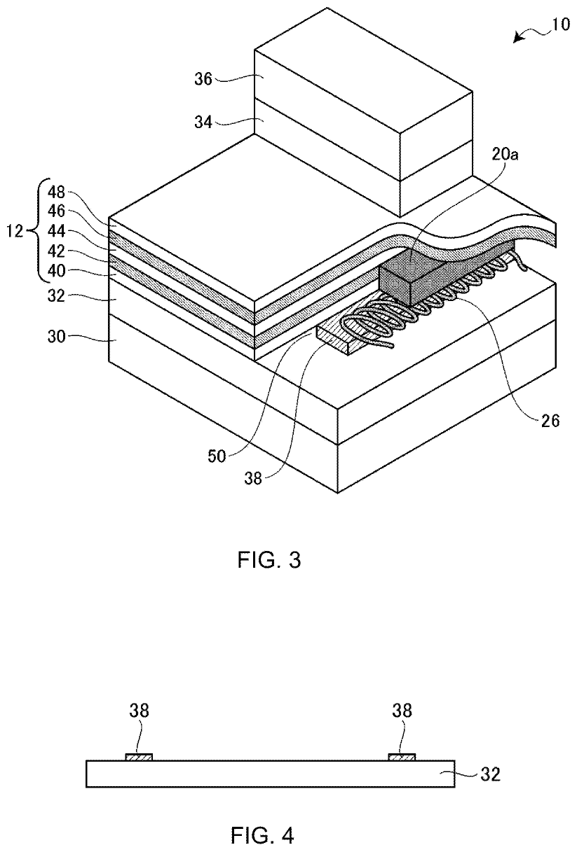

FIG. 1. to FIG. 3 illustrate a laminated glazing having an electrically connectable layer therein. As shown in FIG. 1, an electrically connectable layer 12 may be formed in a rectangular shape with four rounded corners and may be surrounded by interlayers 14 which may be made of a polyvinyl butyral resin (PVB) layers. The electrically connectable layer 12 may have any shape in the laminated glazing 10. The interlayers 14 and the electrically connectable layer 12 are sandwiched by a pair of glass substrates, not shown in FIG. 1. The laminated glazing 10 may further include an opaque layer on part of the glazing, not shown in FIG. 1.

Particularly, the electrically connectable layer 12 shown may be a switchable film having two electrodes, including one segmented electrode having isolated segments 16a to 16g. The segments 16a to 16g have busbars 20a to 20g, respectively, and the busbars 20a to 20g are shown connected to connection wires 22a to 22g, respectively. In some embodiments, a segment may have more than one busbar. The electrically connectable layer 12 has a common busbar 18 electrically connected to a non-segmented electrode in the electrically connectable layer 12. In FIG. 1, the segments 16a to 16g are divided by deletions on an electrode layer that extend parallel to the shorter edges of the electrically connectable layer 12, but the segments can he formed in other positions, such as where the deletions extend perpendicular to the shorter edges of the electrically connectable layer 12. In a modified device, the segments may be provided with sizes different from one another. For example, a center segment may be formed in a larger size than the other segments.

The busbars 20a to 20g and the common busbar 18 are made of a metal material and are electrically connected to the first connection end of the connection wires 22a to 22g, and a connection wire 22h connected to the common busbar 18. Each of the connection wires 22a to 22h include an insulated copper wire. The first connection end and second connection end of each of the connection wires 22a to 22h may be free of insulation that may extend in the main portion of the connection wires 22a to 22h. The first connection end of the wire connections 22a to 22h may be positioned to have a coiled shape or loop shape to gain wider contact areas between the busbars 20a to 20g, 18 and the connection wires 22a to 22h. FIG. 2 illustrates the electrically connectable layer 12 with the busbar 20a and a first connection end 26 of the connection wire 22a. The configuration shown may be the same at other busbars 20b to 20g, 18 on the electrically connectable layer 12. As shown, the first connection end 26 of the connection wire 22a may be provided in a looped or coiled shape which may increase surface area connection with the underlying busbar 20a. In some embodiments, the first connection end 26 of the connection wire 22a may be soldered to the busbar 20a. In some other embodiments, an adhesive layer 38, such as a copper tape having an adhesive thereon, may be positioned on the other side of the first connection end 26. The main portion of the connection wire 22a may extend between interlayers 14 through the glazing periphery around the electrically connectable layer 12 to an area where it may be connected to a power source. The second connection ends of the connection wires 22a to 22g, 22h are connected to a wire harness 24, which is connectable to the power source and a controller for controlling the electrically connectable layer 12. A wire harness connector (not shown) may be provided to extend from the wire harness 24 to outside an edge of the glass substrates.

FIG. 3 shows a perspective cross section showing a portion of a laminated glazing 10 having a switchable film as the electrically connectable layer 12. The electrically connectable layer 12 shown in FIG. 3 may include a switchable layer core 44 including a switchable material, two electrode layers 42, 46 provided respectively on opposite sides of the switchable layer core 44 and having busbars, and first and second film substrates 40, 48, which may be made of a resin such as polyethylene terephthalate film. The electrode layers 42, 46 may be formed on the first and second film substrates 40, 48. The electrically connectable layer 12 having the switchable layer core 44, the electrode layers 42, 46, and the first and second film substrates 40, 48 may be formed as a single film, and layers of the film can be cut out to expose the surfaces of the electrode layers 42, 46 for electrically connecting the layer 12.

The electrically connectable layer 12 in FIG. 3 is positioned between interlayers 32, 34, and the interlayers 32, 34 are positioned between a first glass substrate 30 and a second glass substrate 36. The first and second glass substrates 30, 36 may be a soda-lime silicate glass, and the interlayers 32, 34 may be a polyvinyl butyral resin, as well known in the art. The interlayers 32, 34 may also insulate the connection wires 22a to 22h, and an additional surrounding interlayer may be provided around the electrically connectable layer 12 to avoid a change in thickness at the edge of the electrically connectable layer 12. Such an additional surrounding interlayer may be provided with an opening for fitting the electrically connectable layer 12 therein as described below.

During the assembly process, the busbars 20a to 20g, and the common busbar 18 may be provided at or near the respective edges of the electrically connectable layer 12. To make electrical contact and avoid any short circuit, the busbars 20a to 20g, and the common busbar 18 may be provided with space between the busbar 18, 20a to 20g and the opposite electrode layer 42, 46. The space may be filled with an interlayer in the laminated glazing.

In FIG. 1, the busbars 20a to 20g are provided on one side of the electrically connectable layer 12, however, in some embodiments, some of the busbars 20a to 20g may be provided on each side of the electrically connectable layer 12 to split the number of busbars between the sides. For example, if seven segments are arranged, three busbars may be provided on the right side whereas four busbars may be provided on the left side. Further, where a segment has more than one busbar, the busbars may be preferably positioned on opposite sides of the segments.

Referring to FIG. 4 to FIG. 15, a method of manufacturing the laminated glazing as described above is described in detail. In this method, connection wires may be provided prior to positioning of a surrounding interlayer.

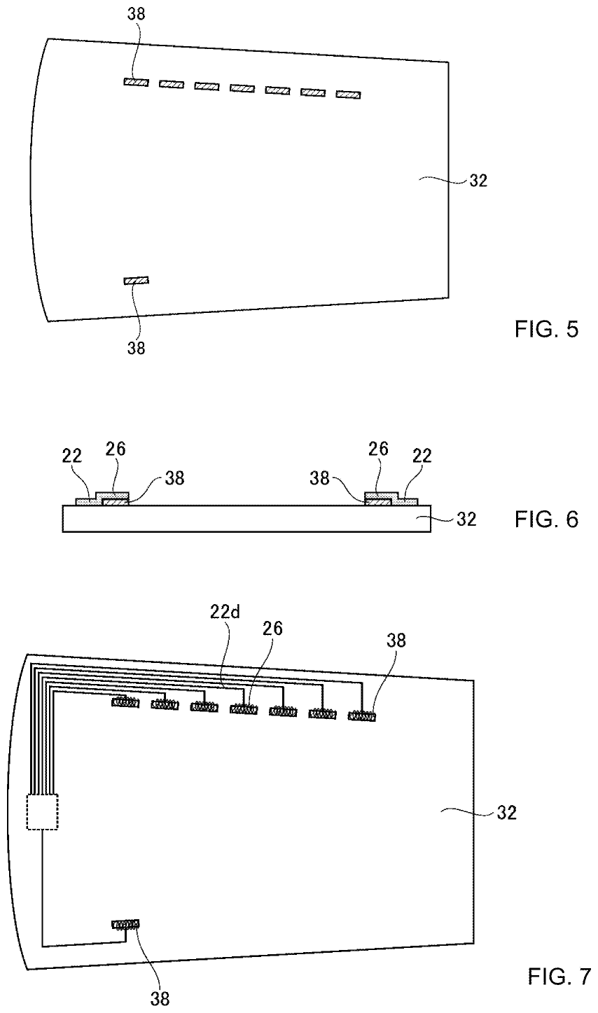

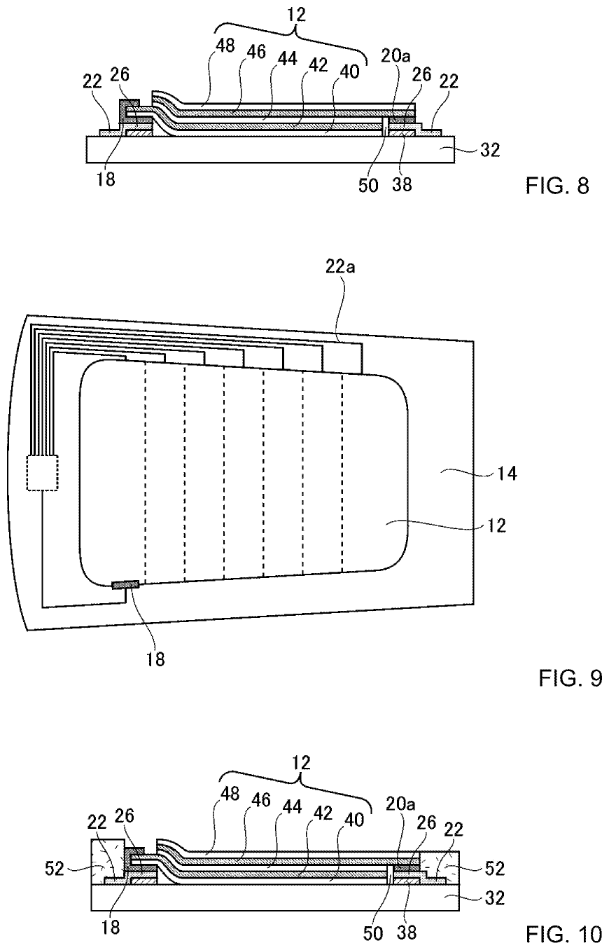

As shown in FIG. 4 and FIG. 5, adhesive layers 38 may be provided at positions on a first interlayer 32 where connection wire first connection ends 26 are to be set. The first interlayer 32 may be a polyvinyl butyral resin (PVB), ethylene vinyl acetate (EVA), or an ionomer as known in the art. The suitable positioning for busbars 18, 20a to 20g and connections wires 22a to 22h may depend on the shape and size of the electrically connectable layer 12 and the laminated glazing 10. The adhesive layers 38 may be preferably made of a conductive material such as silver paste, or carbon containing adhesive, and the adhesive layer 38 itself may be made of a conductive tape such as a copper tape which may include a conductive paste. The adhesive layer 38 may secure contact between the busbar and the connection wire prior to lamination and maintain the positions of the busbar to be located at the boundary of the electrically connectable layer 12. The adhesive layer 38 may fix the connection wire to the busbar even when the interlayer becomes soft during deairing and autoclaving processes to provide electrical contact to electrode 42 and contact a connection wire 22h on the same side of the electrically connectable layer 12 as busbars 20a to 20g contact connection wires 22a to 22g, as shown in FIG. 8. The common busbar 18 may include an extension to provide a suitable material for folding around the edge of the electrically connectable layer 12. For example, the busbar 18 may include a first busbar material, which may include a conductive material, such as discussed above, and a conductive tape extension for folding around the electrically connectable layer 12. The conductive tape may include a conductive adhesive for electrically connecting to the first busbar material. The connection wire 22h may connect at the folded over portion of the busbar 18.

As described above, the switchable layer core 44 may be made of a switchable material, surrounded by the two electrode layers 42, 46 electrically connected to the busbars. The electrode layers 42, 46 may be made of ITO film or other transparent conductive films. The first and second film substrates 40, 48 may be made of a resin such as polyethylene terephthalate film. The electrically connectable layer 12 may be segmented by dividing the second electrode layer 46 into electrically isolated portions or segments by laser deletion or any other suitable method.

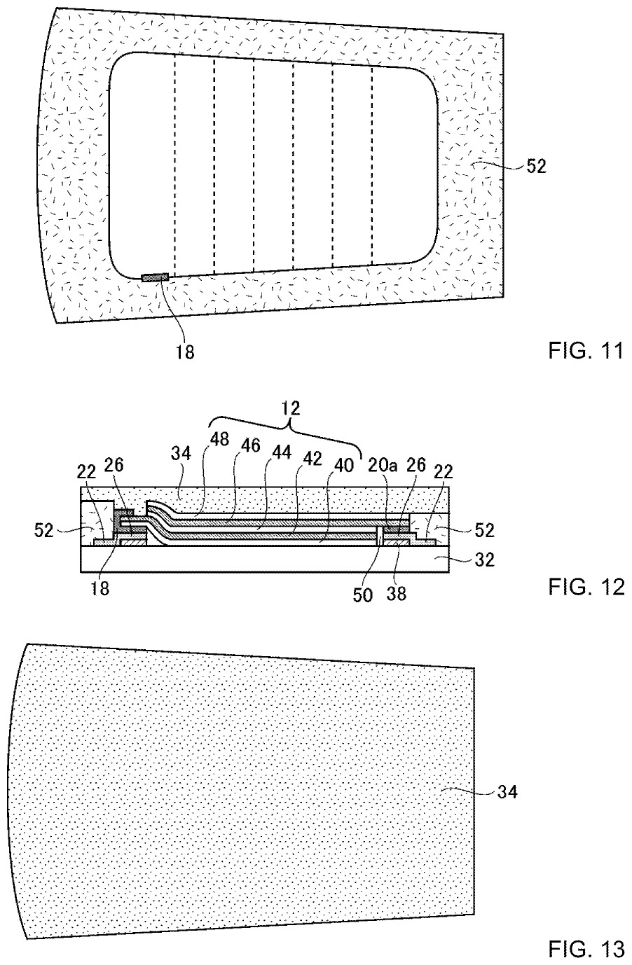

To prevent a change in thickness of the materials at the edge of the electrically connectable layer 12, a surrounding interlayer 52 may be provided around the electrically connectable layer 12 as shown in FIG. 10 and FIG. 11. The surrounding interlayer 52 may have an opening to fit the contour of the electrically connectable layer 12 and have a thickness substantially close to that of the electrically connectable layer 12. The surrounding interlayer 52 and the first interlayer 32 may be fixed together so that they do not change position prior to lamination of the materials. The surrounding interlayer may be polyvinyl butyral (PVB), ethylene vinyl acetate (EVA), or an ionomer. In this process, the electrically connectable layer 12 is positioned first and then, the surrounding interlayer 52 is positioned subsequently, but in some methods, the surrounding interlayer 52 may be positioned before positioning the electrically connectable layer 12.

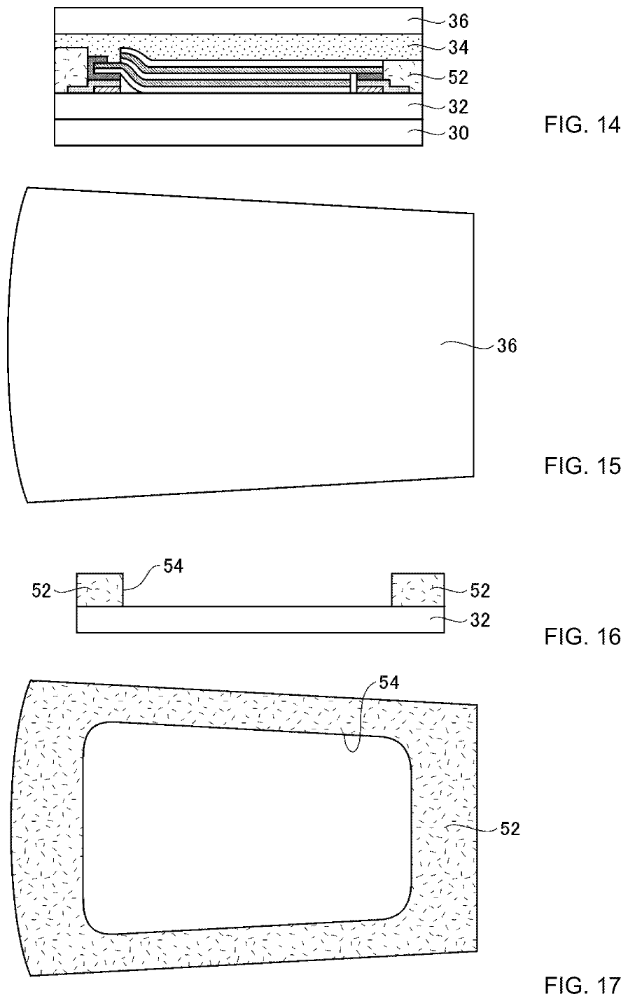

After positioning the electrically connectable layer 12 and the surrounding interlayer 52, a second interlayer 34 may be provided over the entire surface of the electrically connectable layer 12 and the surrounding interlayer 52 as shown in FIG. 12 and FIG. 13. The second interlayer 34 may be fixed to the surrounding interlayer 52. The second interlayer may be a polyvinyl butyral (PVB), ethylene vinyl acetate (EVA), or an ionomer. Subsequently, the interlayer stack including the interlayers 32, 34, 52 and the electrically connectable layer 12 may be positioned between a first glass substrate 30 and a second glass substrate 36 as shown in FIG. 14 and FIG. 15. The first and second glass substrates 30, 36 may include soda-lime silicate glass substrates.

This glazing stack may then be subject to lamination, including deairing and autoclaving processes. During the deairing process, air inside the glazing stack is removed to the exterior of the stack. In order to deair the air around an interlayer, the interlayer may have an embossed surface before the deairing and autoclaving processes. Air located around the connection wires may be smoothly withdrawn because the connection wires may not substantially block the withdrawal of air, because the connection wire has a small diameter and/or is embedded in the interlayer. During lamination, the interlayer material may soften and till any space remaining between the layers.

Referring to FIG. 16 to FIG. 23, another manufacturing method of the laminated glazing as described above is described in detail. In this method, connection wires 22a to 22h are provided after positioning of a surrounding interlayer 52 and the electrically connectable layer 12.

As shown in FIG. 16 and FIG. 17, a surrounding interlayer 52 may be positioned on a first interlayer 32 around an area in which the electrically connectable layer 12 is to be positioned. The surrounding interlayer may include an opening 54 to fit around the electrically connectable layer 12. The surrounding interlayer 52 may be fixed to the first interlayer 32. The first interlayer 32 and the surrounding interlayer 52 may be polyvinyl butyral (PVB), ethylene vinyl acetate (EVA), or an ionomer.

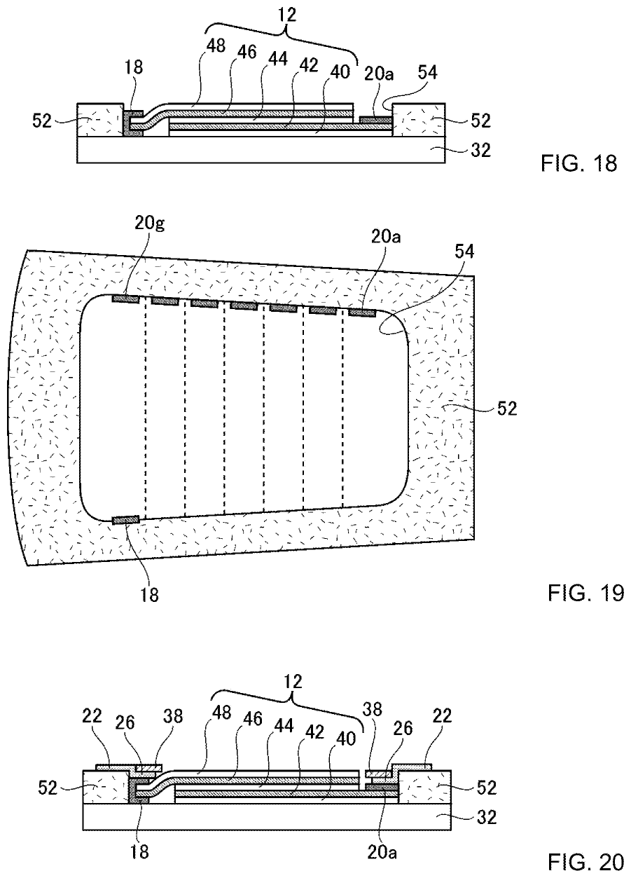

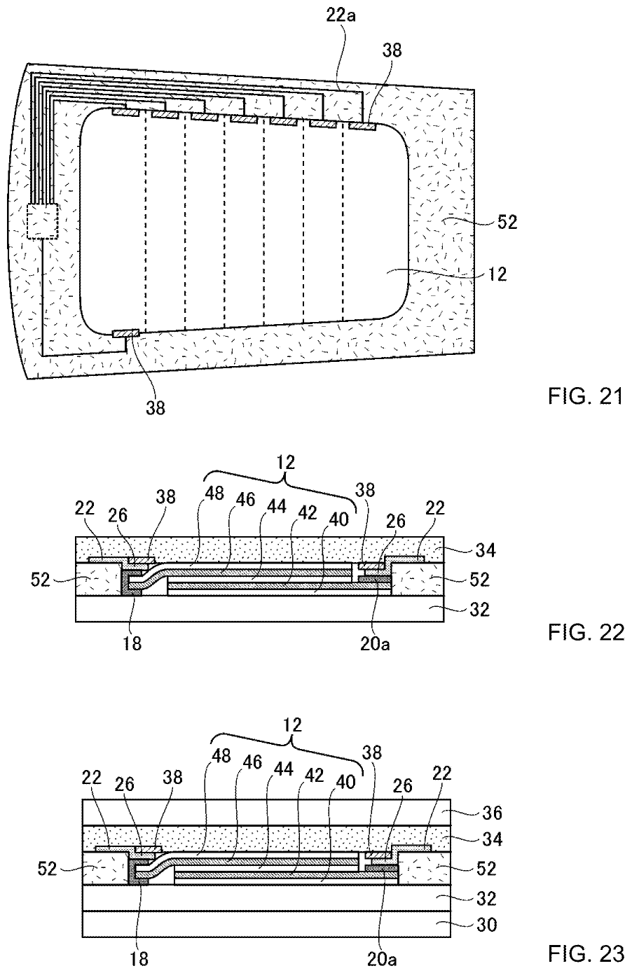

Subsequent to the positioning of the surrounding interlayer 52, as shown in FIG. 18 and FIG. 19, the electrically connectable layer 12, having busbars 18, 20a to 20g formed thereon, is provided on the first interlayer 32 within the opening 54. A portion of the common busbar 18 may be folded over the electrically connectable layer 12 so as to be connected to a connection wire first end 26 when positioned on the first interlayer 32 on the same side of the electrically connectable layer 12 as the other busbars 20a to 20g. In some methods, the electrically connectable layer 12 may be positioned on the first interlayer 32 prior to placement of the surrounding interlayer 52 around the electrically connectable layer 12.

Where the common busbar 18 is arranged in a folded fashion and where the other busbars 20a to 20g are arranged to the exposed areas of the upper surface of the first electrode layer 42, connection wires 22a to 22h are provided to make electrical connections to the busbars 18, 20a to 20g as shown in FIG. 20 and FIG. 21. The first connection ends 26 may extend in a coiled or looped shape to increase the contact area between the connection wires 22a to 22h and the busbars 18, 20a to 20g in substantially the same way as described above. The main portions and the second connection ends of the connection wires 22a to 22h are structured in substantially the same way as described above. Particularly, the main portions of the connection wires 22a to 22h extend over and may be embedded in the surrounding interlayer 52. An adhesive layer 38 may be provided over the busbars 18, 20a to 20g, and the first connection ends 26. The adhesive layer 38 may be preferably made of a conductive material such as silver paste, or carbon containing adhesive, and the adhesive layer 38 itself may be made of a conductive tape such as a copper tape which may include a conductive paste.

After positioning the connection wires 22a to 22h, a second interlayer 34 may be positioned on the electrically connectable layer 12 and the surrounding interlayer 52 as shown in FIG. 22. The second interlayer 34 may be fixed to the surrounding interlayer 52 and may be a polyvinyl butyral (PVB), ethylene vinyl acetate (EVA), or an ionomer. Then, the interlayer stack including interlayers 32, 34, 52 and the electrically connectable layer 12 may be positioned between a first glass substrate 30 and a second glass substrate 36 as shown in FIG. 23.

Subsequently, this glazing stack is subject to deairing and autoclaving processes. During the deairing process, air inside the glazing stack is smoothly withdrawn to the exterior of the stack. The interlayer material may soften and fill the any space remaining between the layers during these processes.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A laminated glazing having an electrically connectable layer, comprising:
first and second glass substrates;
an electrically connectable layer;
interlayers, wherein the electrically connectable layer is positioned between interlayers; and
at least one connection wire having first and second connection ends and a main portion positioned between the first and second connection ends, wherein the first connection end of the connection wire is electrically connected to the electrically connectable layer, wherein the main portion of the connection wire is positioned within the interlayers.

2. The laminated glazing according to claim 1, wherein the electrically connectable layer comprises a switchable film.

3. (canceled)

4. (canceled)

5. (canceled)

6. The laminated glazing according to claim 2, wherein the switchable film comprises a switchable layer core positioned between first and second electrode layers, wherein the first electrode layer is coated on a first film substrate and the second electrode is coated on a second film substrate, and wherein the first electrode layer comprises at least two segments wherein the segments are electrically isolated from one another and are each electrically connected to separate connection wires via a busbar on each segment, and wherein the second electrode layer is electrically connected to another connection wire which is different from the connection wires electrically connected to the segments, wherein each busbar overlaps with the first connection end of at least one of the connection wires.

7. (canceled)

8. (canceled)

9. (canceled)

10. (canceled)

11. (canceled)

12. (canceled)

13. The laminated glazing according to claim 1, wherein the first connection end of the connection wire has a looped shape or a zigzag shape.

14. (canceled)

15. (canceled)

16. (canceled)

17. The laminated glazing according to claim 1, wherein the first connection end is adhered to a busbar on the electrically connectable layer by an adhesive layer.

18. (canceled)

19. (canceled)

20. (canceled)

21. (canceled)

22. A method of preparing a laminated glazing, comprising:
placing at least one connection wire on a first interlayer, wherein each of the at least one connection wires includes a first connection end, a main portion and a second connection end, wherein placing the at least one connection wire includes embedding the main portion of the connection wire in the first interlayer,
placing an electrically connectable layer over the first interlayer such that at least one busbar on the electrically connectable layer overlaps with the first connection end of the at least one connection wire and placing a surrounding interlayer over the first interlayer around the electrically connectable layer, wherein the main portion of the connection wire is positioned between the first interlayer and the surrounding interlayer;
placing a second interlayer over the electrically connectable layer and the surrounding interlayer to provide an interlayer stack;
placing the interlayer stack between a first glass substrate and second glass substrate to provide a lamination stack; and
laminating the lamination stack to provide a laminated glazing.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. A method of preparing a laminated glazing, comprising:
placing a surrounding interlayer and an electrically connectable layer having at least one busbar on a first interlayer such that the electrically connectable layer fits within the surrounding interlayer;
placing at least one connection wire on the surrounding interlayer and electrically connectable layer, wherein each connection wire includes a first connection end, a main portion, and a second connection end, wherein the first connection end overlaps with one of the at least one busbars, and wherein the main portion of each connection wire is embedded in the surrounding interlayer;
placing a second interlayer over the electrically connectable layer and the surrounding interlayer to provide an interlayer stack, wherein the main portion of the connection wire extends between the surrounding interlayer and the second interlayer;
placing the interlayer stack between a first glass substrate and a second glass substrate to provide a lamination stack; and
laminating the lamination stack to provide a laminated glazing.

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. A method of preparing a laminated glazing, comprising:
placing an electrically connectable layer surrounded by a surrounding interlayer on a first interlayer, wherein the electrically connectable layer having at least one busbar is electrically connected with at least one connection wire;
placing a second interlayer over the electrically connectable layer and the surrounding interlayer to provide an interlayer stack; and
placing the interlayer stack between a first glass substrate and a second glass substrate to provide a lamination stack; and
laminating the lamination stack to provide a laminated glazing;
wherein each connection wire has first and second connection ends and a main portion positioned between the first and second connection ends,
wherein the first connection end of the connection wire is electrically connected to the electrically connectable layer, and
wherein the main portion of the connection wire is positioned between the surrounding interlayer and one of the first and second interlayers.

48. The method according to claim 47, wherein the step of placing the electrically connectable layer surrounded by the surrounding interlayer on the first interlayer with the connection wire comprises:
placing the connection wire on the first interlayer;
placing the electrically connectable layer on the first interlayer such that the busbar on the electrically connectable layer overlaps with the first connection end of the connection wire; and
placing the surrounding interlayer on the first interlayer, around the electrically connectable layer.

49. The method according to claim 47, wherein the step of placing the electrically connectable layer surrounded by the surrounding interlayer on the first interlayer with the connection wire comprises:
placing the connection wire on the first interlayer;
placing the surrounding interlayer on the first interlayer, wherein the surrounding interlayer includes an opening through the surrounding interlayer; and
placing the electrically connectable layer on the first interlayer within the opening in the surrounding interlayer such that the busbar on the electrically connectable layer overlaps with the first connection end of the connection wire.

50. The method according to claim 47, wherein the step of placing the electrically connectable layer surrounded by the surrounding interlayer on the first interlayer with the connection wire comprises:
placing an electrically connectable layer on the first interlayer;
placing the surrounding interlayer on the first interlayer, around the electrically connectable layer; and
placing the at least one connection wire on the surrounding interlayer and electrically connectable layer, wherein the first connection end of each connection wire overlaps with one of the at least one busbars.

51. The method according to claim 47, wherein the step of placing the electrically connectable layer surrounded by the surrounding interlayer on the first interlayer with the connection wire comprises:
placing the surrounding interlayer on the first interlayer, wherein the surrounding interlayer includes an opening through the surrounding interlayer;
placing the electrically connectable layer within the opening in the surrounding interlayer; and
placing the at least one connection wire on the surrounding interlayer and the electrically connectable layer, wherein the first connection end of each connection wire overlaps with one of the at least one busbars.

52. The method according to claim 47, wherein the first connection end of the connection wire has a looped shape.

53. The method according to claim 47, wherein the first connection end of the connection wire has a zigzag shape.

54. The method according to claim 47, wherein the electrically connectable layer comprises at least two electrically isolated portions, wherein each electrically isolated portion includes at least one separate busbar which overlap with separate connection wire first connection ends.

55. The method according to claim 48, wherein placing the at least one connection wire on the first interlayer comprises embedding the main portion of the connection wire in the first interlayer.

56. The method according to claim 50, wherein placing the at least one connection wire on the surrounding interlayer comprises embedding the main portion of the connection wire in the surrounding interlayer.

57. The method according to claim 48, wherein an adhesive layer is placed on the first layer before placing the at least one connection wire wherein the first connection end at least partially aligns with the adhesive layer.

58. The method according to claim 50, wherein an adhesive layer is placed at least partially over the first connection end on the at least one busbar after placing the at least one connection wire.

59. (canceled)

60. (canceled)

61. (canceled)

62. (canceled)

63. (canceled)

64. The method according to claim 47, wherein the electrically connectable layer comprises a switchable film.
